(19) United States
(12) Patent Application Publication
(10) Pub. No.: US 2022/0172421 A1
(43) Pub. Date: Jun. 2, 2022

(54) Enhancement of Three-Dimensional Facial Scans

(71) Applicant: Huawei Technologies Co., Ltd., Shenzhen (CN)

(72) Inventors: Stylianos Moschoglou, London (GB); Stylianos Ploumpis, London (GB); Stefanos Zafeiriou, London (GB)

(21) Appl. No.: 17/436,793

(22) PCT Filed: Mar. 5, 2020
(86) PCT No.: PCT/GB2020/050525

§ 371 Date: Sep. 7, 2021

(30) Foreign Application Priority Data
Mar. 6, 2019 (GB) 1903017.0

(51) Int. Cl. G06T 15/00; G06N 3/04

(52) U.S. Cl. CPC G06T 15/00; G06N 3/0454; G06T 2207/20081; G06T 2207/30201; G06T 2207/10048; G06T 2207/20084

(57) ABSTRACT

A method includes applying a generator neural network to a low quality spatial UV map to generate a candidate high quality spatial UV map, applying a discriminator neural network to the candidate high quality spatial UV map to generate a reconstructed candidate high quality spatial UV map, applying the discriminator neural network to a high quality ground truth spatial UV map to generate a reconstructed high quality ground truth spatial UV map, updating parameters of the generator neural network based on a comparison of the candidate high quality spatial UV map and the reconstructed candidate high quality spatial UV map, and updating parameters of the discriminator neural network.

### FIELD

This specification describes methods for enhancing three-dimensional facial data using neural networks, and methods of training neural networks for enhancing three-dimensional facial data.

### BACKGROUND

Image-to-image translation is a ubiquitous problem in image processing, in which an input image is transformed to a synthetic image that maintains the some properties of the original input image. Examples of image-to-image translation include converting images from black-and-white to colour, turning daylight scenes into night-time scenes, increasing the quality of images and/or manipulating facial attributes of an image. However, current methods of performing image-to-image translation are limited to two-dimensional (2D) texture images.

The capture and use of three-dimensional (3D) image data is becoming increasingly common with the introduction of depth cameras. However, the use of shape-to-shape translation (a 3D analogue to image-to-image translation) on such 3D image data is limited by several factors, including the low-quality output of many depth cameras. This is especially the case in 3D facial data, where non-linearities are often present.

### SUMMARY

According to a first aspect of this disclosure, there is described a method of training a generator neural network to convert low-quality three-dimensional facial scans to high quality three-dimensional facial scans, the method comprising jointly training a discriminator neural network and a generator neural network, wherein the joint training comprises: applying the generator neural network to a low quality spatial UV map to generate a candidate high quality spatial UV map; applying the discriminator neural network to the candidate high quality spatial UV map to generate a reconstructed candidate high quality spatial UV map; applying the discriminator neural network to a high quality ground truth spatial UV map to generate a reconstructed high quality ground truth spatial UV map, wherein the high quality ground truth spatial UV map corresponds to the low quality spatial UV map; updating parameters of the generator neural network based on a comparison of the candidate high quality spatial UV map and the reconstructed candidate high quality spatial UV map; and updating parameters of the discriminator neural network based on a comparison of the candidate high quality spatial UV map and the reconstructed candidate high quality spatial UV map and a comparison of the high quality ground truth spatial UV maps and the reconstructed high quality ground truth spatial UV map. A comparison between the candidate high quality spatial UV map and the corresponding ground truth high quality spatial UV map may additionally be used when updating the parameters.

The generator neural network and/or the discriminator neural network may comprise a set of encoding layers operable to convert an input spatial UV map to an embedding and a set of decoding layers operable to convert the embedding to an output spatial UV map. The parameters of one or more of the decoding layers may be fixed during the joint training of the generator neural network and the discriminator neural network. The decoding layers of the generator neural network and/or the discriminator neural network may comprise one or more skip connections in an initial layer of the decoding layers.

The generator neural network and/or the discriminator neural network may comprise a plurality of convolutional layers. The generator neural network and/or the discriminator neural network may comprise one or more fully connected layers. The generator neural network and/or the discriminator neural network may comprise one or more upsampling and/or subsampling layers. The generator neural network and the discriminator neural network may have the same network structure.

Updating parameters of the generator neural network may be further based on a comparison between the candidate high quality spatial UV map and the corresponding high quality ground truth spatial UV map.

Updating parameters of the generator neural network may comprise: using a generator loss function to calculate a generator loss based on a difference between the candidate high quality spatial UV map and the corresponding reconstructed candidate high quality spatial UV map; and applying an optimisation procedure to the generator neural network to update the parameters of the generator neural network based on the calculated generator loss. The generator loss function may further calculate the generator loss based on a difference between the candidate high quality spatial UV map and the corresponding high quality ground truth spatial UV map.

Updating parameters of the discriminator neural network may comprise: using a discriminator loss function to calculate a discriminator loss based on a difference between the candidate high quality spatial UV map and the reconstructed candidate high quality spatial UV map and a difference between the high quality ground truth spatial UV map and the reconstructed high quality ground truth spatial UV map; and applying an optimisation procedure to the discriminator neural network to update the parameters of the discriminator neural network based on the calculated discriminator loss.

The method may further comprise pre-training the discriminator neural network to reconstruct high quality ground truth spatial UV maps from input high quality ground truth spatial UV maps.

According to a further aspect of this disclosure, there is described a method of converting low-quality three-dimensional facial scans to high quality three-dimensional facial scans, the method comprising: receiving a low quality spatial UV map of a facial scan; applying a neural network to the low quality spatial UV map; outputting from the neural network a high quality spatial UV map of the facial scan, wherein the neural network is a generator neural network trained using any of the training methods described herein.

According to a further aspect of this disclosure, there is described apparatus comprising: one or more processors; and a memory, wherein the memory comprises computer readable instructions that, when executed by the one or more processors, cause the apparatus to perform one or more of the methods described herein.

According to a further aspect of this disclosure, there is described a computer program product comprising computer readable instructions that, when executed by a computer, cause the computer to perform one or more of the methods described herein.

As used herein, the term quality may preferably be used to connote any one or more of: a noise level (such as a peak signal-to-noise ratio); a texture quality; an error with respect to a ground truth scan; and 3D shape quality (which may, for example, refer to how well high frequency details are retained in the 3D facial data, such as eyelid and/or lip variations).

### BRIEF DESCRIPTION OF THE DRAWINGS

Embodiments will now be described by way of non-limiting examples with reference to the accompanying drawings, in which:

FIG. 1 shows an overview of an example method of enhancing 3D facial data using a neural network;

FIG. 2 shows an overview of an example method of training a neural network for enhancing 3D facial data;

FIG. 3 shows a flow diagram of an example method of training a neural network for enhancing 3D facial data;

FIG. 4 shows an overview of an example method of pre-processing 3D facial data;

FIG. 5 shows an overview of an example method of pre-training a discriminator neural network;

FIG. 6 shows an example of the structure of a neural network for enhancing 3D facial data; and

FIG. 7 shows a schematic example of a computing system.

### DETAILED DESCRIPTION

Raw 3D facial scans captured by some 3D camera systems may often be of low quality, for example by having a low surface detail and/or being noisy. This may, for example, be a result of the method the camera used to capture the 3D facial scans or due to the technical limitations of the 3D camera system. However, applications that use the facial scans may require the scans to be of a higher quality than the facial scans captured by the 3D camera system.

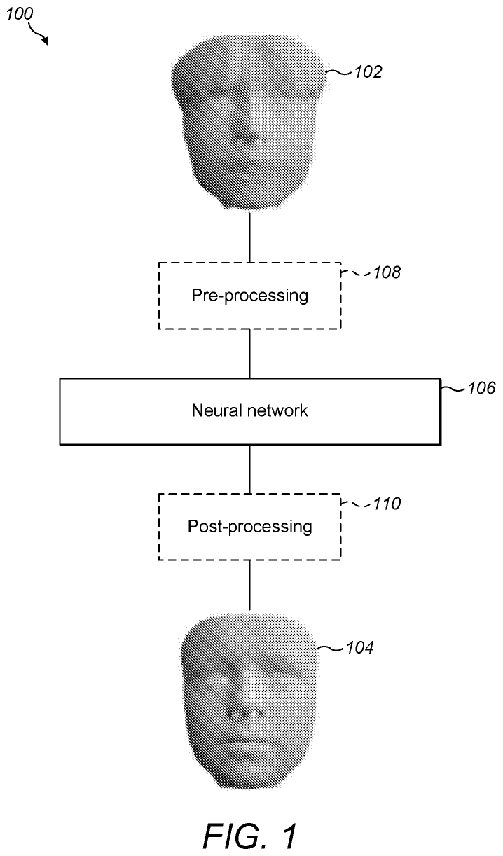

FIG. 1 shows an overview of an example method of enhancing 3D facial data using a neural network. The method 100 comprises receiving low quality 3D facial data 102 and generating high quality 3D facial data 104 from the low quality 3D facial data 102 using a neural network 106.

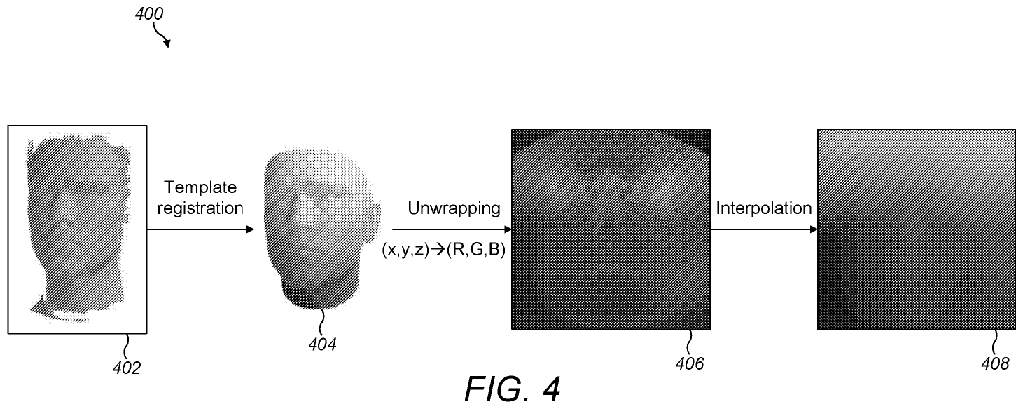

The low-quality 3D facial data 102 may comprise a UV map of a low quality 3D facial scan. Alternatively, the low-quality 3D facial data 102 may comprise a 3D mesh representing a low quality 3D facial scan. The 3D mesh may be converted into a UV map in a pre-processing step 108. An example of such a pre-processing step is described below in relation to FIG. 4.

A spatial UV map is a two dimensional representation of a 3D surface or mesh. Points in 3D space (for example described by (x, y, z) co-ordinates) are mapped onto a two-dimensional space (described by (u, v) co-ordinates). The UV map may be formed by unwrapping a 3D mesh in a 3D space onto the u-v plane in the two-dimensional UV space. In some embodiments, the (x, y, z) co-ordinates of the 3D mesh in the 3D space are stored as RGB values of corresponding points in the UV space. The use of a spatial UV map allows two-dimensional convolutions to be used when increasing the quality of the 3D scan, rather than geometric deep learning methods, which tend to mainly preserve low-frequency details of the 3D meshes.

The neural network 106 comprises a plurality of layers of nodes, each node associated with one or more parameters. The parameters of each node of the neural network may comprise one or more weights and/or biases. The nodes take as input one or more outputs of nodes in the previous layer. The one or more outputs of nodes in the previous layer are used by the node to generate an activation value using an activation function and the parameters of the neural network.

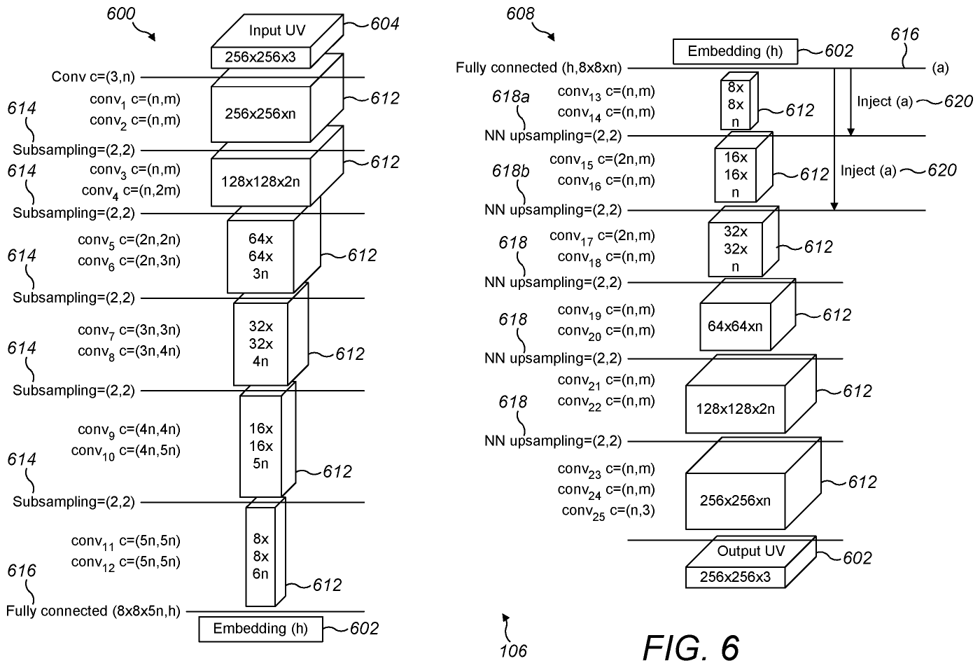

The neural network 106 may have the architecture of an autoencoder. Examples of neural network architectures are described below in relation to FIG. 6.

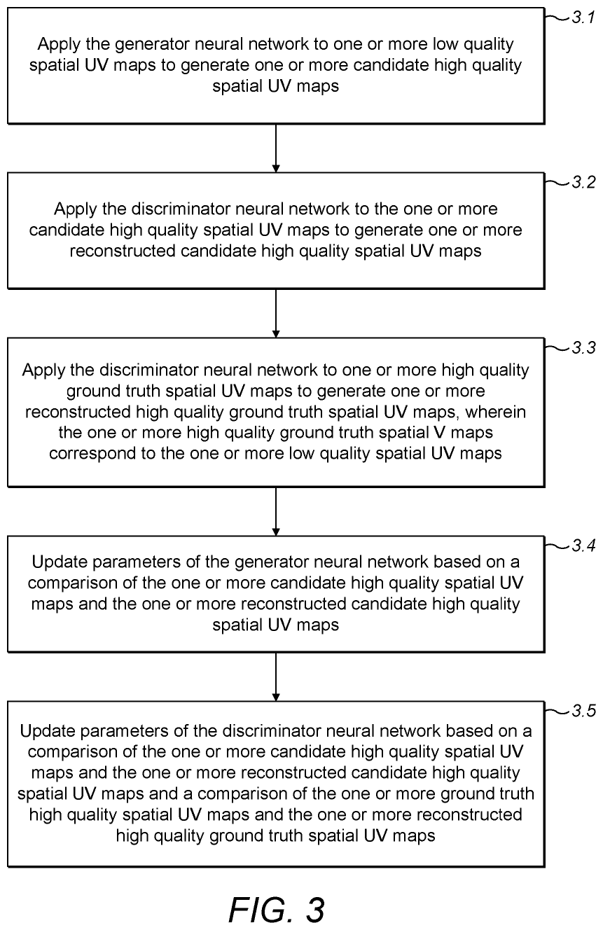

The parameters of the neural network 106 may be trained using generative adversarial training, and the neural network 106 may therefore be referred to as a Generative Adversarial Network (GAN). The neural network 106 may be the generator network of the Generative Adversarial Training. Examples of training methods are described below in relation to FIGS. 3 to 5.

The neural network generates high quality 3D facial data 104 using the UV map of the low quality 3D facial scan. The high quality 3D facial data 104 may comprise a high quality UV map. The high quality UV map may be converted into a high-quality 3D spatial mesh in a post-processing step 110.

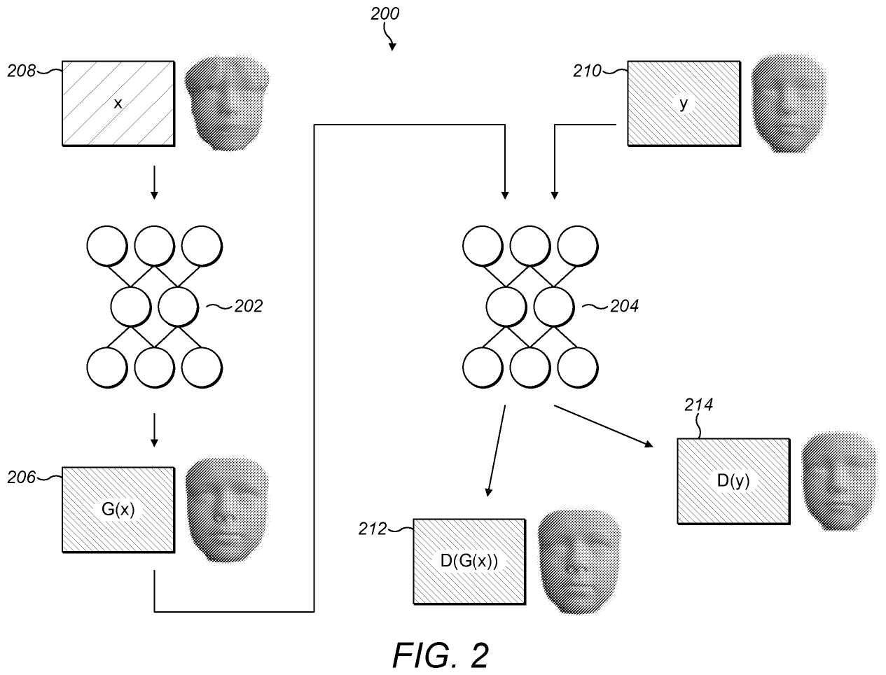

FIG. 2 shows an overview of an example method of training a neural network for enhancing 3D facial data. The method 200 comprises jointly training a generator neural network 202 and discriminator neural network 204 in an adversarial manner. The objective of the generator neural network 202 during training is to learn to generate high quality UV facial maps 206 from input low-quality UV facial maps (also referred to herein as low-quality spatial UV maps) 208 that are close to the corresponding ground truth UV facial maps (also referred to herein as real high quality UV facial maps and/or high-quality ground truth spatial UV maps) 210. The set of pairs (x, y) of low quality spatial UV maps, x, and high quality ground truth spatial UV maps, y, may be referred to as the training set/data. The training dataset may be constructed from raw facial scans using a pre-processing method, as described below in more detail with respect to FIG. 4.

The objective of the discriminator neural network 204 during training is to learn to distinguish between ground truth UV facial maps 210 and generated high quality UV facial maps 206 (also referred to herein as fake high quality UV facial maps, or candidate high quality spatial UV maps). The discriminator neural network 204 may have the structure of an autoencoder.

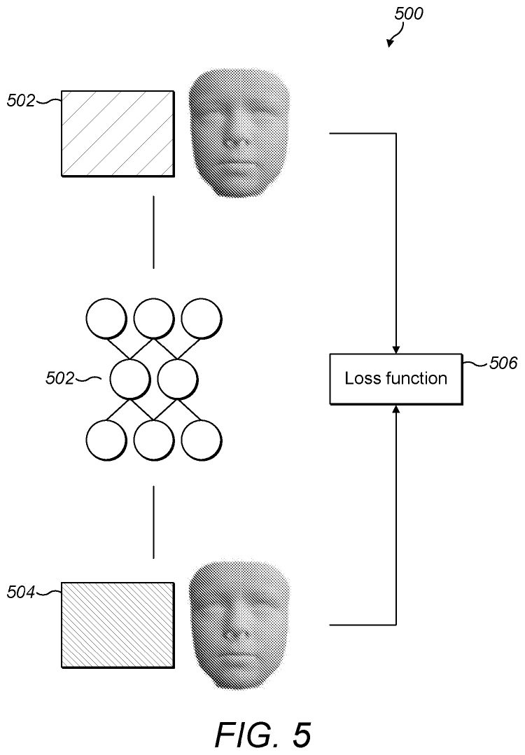

In some embodiments, the discriminator neural network 204 may be pre-trained on pre-training data, as described below in relation to FIG. 5. In embodiments where the discriminator 204 and generator 202 neural networks have the same structure, the parameters of the pre-trained discriminator 204 neural network may be used to initialize both the discriminator 204 and the generator 202 neural networks.

During the training process, the generator neural network 202 and the discriminator neural network 204 compete against each other until they reach a threshold/equilibrium condition. For example, the generator neural network 202 and the discriminator neural network 204 compete with each other until the discriminator neural network 204 can no longer distinguish between real and fake UV facial maps.

During the training process, the generator neural network 202 is applied to a low quality spatial UV map 208, x, taken from the training data. The output of the generator neural network is a corresponding candidate high quality spatial UV map 206, G(x).

The discriminator neural network 204 is applied to the candidate high quality spatial UV map 206 to generate a reconstructed candidate high quality spatial UV map 212, D(G(x)). The discriminator neural network 204 is also applied to the high quality ground truth spatial UV map 210, y, that corresponds to the low quality spatial UV map 208, x, to generate a reconstructed high quality ground truth spatial UV map 214, D(y).

A comparison of the candidate high quality spatial UV map 206, G(x) and the reconstructed candidate high quality spatial UV map 212, D(G(x)), is performed and used to update parameters of the generator neural network. A comparison of the high quality ground truth spatial UV map 210, y, and the reconstructed high quality ground truth spatial UV map 214, D(y), may also be performed, and used along with the comparison of the candidate high quality spatial UV map 206 and the reconstructed candidate high quality spatial UV map 212 to update the parameters of the discriminator neural network. The comparisons may be performed using one or more loss functions. In some embodiments, the loss functions are calculated using the results of applying the generator neural network 202 and discriminator neural network 204 to a plurality of pairs of low quality spatial UV maps 208, and high quality ground truth spatial UV maps 210.

In some embodiments, adversarial loss functions can be used. An example of an adversarial loss is the BEGAN loss. The loss functions for the generator neural network [symbol] _{G}, also referred to herein as the generator loss) and the discriminator neural network (L_{D}, also referred to herein as the discriminator loss) may be given by:

$${ℒ}_{D} = {𝔼}_{y} [ ℒ ( y ) ] - {k}_{t} \cdot {𝔼}_{x} [ ℒ ( G ( x ) ) ]$$

$${ℒ}_{G} = {𝔼}_{x} [ ℒ ( G ( x ) ) ]$$

$${k}_{t + 1} = {k}_{t} + {λ}_{k} ( γℒ ( y ) - ℒ ( G ( x ) ) )$$

where t labels the update iteration (e.g. t=o for the first update to the networks, t=1 for the second set of updates the networks), L(z) is a metric comparing its input, z, to the corresponding output of the discriminator D(z), kₜ is a parameter controlling how much weight should be put on L(G(x)), λₖ is a learning rate for kₜ and y∈[0,1] is a hyperparameter controlling the equilibrium [symbol] _{y}[L(y)]=γ· [symbol] ₓ[L(G(x))]. The hyper parameters may take the values γ=0.5 and λ=10, with kₜ initialised with a value of 0.001. However, other values could alternatively be used. In some embodiments, the metric L(z) is given by L(z)=∥z−D(z)∥₁, though it will be appreciated that other examples are possible. [symbol] _{z} denotes an expectation value over an ensemble of training data.

During training, the discriminator neural network 204 is trained to minimise [symbol] _{D}, while the generator neural network 202 is trained to minimise [symbol] _{G}. Effectively, the generator neural network 202 is trained to “fool” the discriminator neural network 204.

In some embodiments, updates to the generator neural network parameters may be further based on a comparison of the candidate high quality spatial UV map 206 and the high quality ground truth spatial UV map 210. The comparison may be performed using an additional term in the generator loss, referred to herein as the reconstruction loss, [symbol] _{rec}. The full generator loss, [symbol] _{G} may then be given by

$${ℒ}_{G}^{′} = {ℒ}_{G} + λ \cdot {ℒ}_{rec}$$

where λ is a hyper-parameter controlling how much emphasis is placed on the reconstruction loss. An example of the reconstruction loss is [symbol] _{rec}= [symbol] ₓ(∥G(x)−y∥₁), though it will be appreciated that other examples are possible.

The comparisons may be used to update the parameters of the generator and/or discriminator neural networks using an optimisation procedure/method that aims to minimise the loss functions described above. An example of such a method is a gradient descent algorithm. An optimisation method may be characterised by a learning rate that characterises the “size” of the steps taken during each iteration of the algorithm. In some embodiments where gradient descent is used, the learning rate may initially be set to 5e(−5) for both the generator and discriminator neural networks.

During the training, the learning rate of the training process may be changed after a threshold number of epochs and/or iterations. The learning rate may be reduced after every N iterations by a given factor. For example, the learning rate may decay by 5% after each 30 epochs of training.

Different learning rates may be used for different layers of the neural networks 202, 204. For example, in embodiments where the discriminator neural network 204 has been pre-trained, one or more layers of the discriminator 204 and/or generator 202 neural networks may be frozen during the training process (i.e. have a learning rate of zero). Decoder layers of the discriminator 204 and/or generator 202 neural networks may be frozen during the training process. Encoder and bottleneck parts of the neural networks 202, 204 may have a small learning rate to prevent their values significantly diverging from those found in pre-training. These learning rates can reduce the training time and increase the accuracy of the trained generator neural network 106.

The training process may be iterated until a threshold condition is met. The threshold condition may, for example be a threshold number of iterations and/or epochs. For example, the training may be performed for three-hundred epochs. Alternatively or additionally, the threshold condition may be that the loss functions are each optimised to within a threshold value of their minimum value.

FIG. 3 shows a flow diagram of an example method of training a neural network to convert low-quality 3D facial scans to high quality 3D facial scans. The flow diagram corresponds to the methods described above in relation to FIG. 2.

At operation 3.1, a generator neural network is applied to a low quality spatial UV map to generate a candidate high quality spatial UV map. The generator neural network may have the structure of an autoencoder, and comprise a set of encoder layers operable to generate an embedding of the low quality spatial UV map and a set of decoder layers operable to generate a candidate high quality spatial UV map from the embedding. The generator neural network is described by a set of generator neural network parameters (e.g. the weights and biases of the neural network nodes in generator neural network).

At operation 3.2, a discriminator neural network is applied to the candidate high quality spatial UV map to generate a reconstructed candidate high quality spatial UV map. The discriminator neural network may have the structure of an autoencoder, and comprise a set of encoder layers operable to generate an embedding of the input spatial UV map and a set of decoder layers operable to generate an output high quality spatial UV map from the embedding. The discriminator neural network is described by a set of discriminator neural network parameters (e.g. the weights and biases of the neural network nodes in discriminator neural network).

At operation 3.3, the discriminator neural network is applied to a high quality ground truth spatial UV map to generate a reconstructed high quality ground truth spatial UV map, wherein the high quality ground truth spatial UV map corresponds to the low quality spatial UV map. The high quality ground truth spatial UV map and the low quality spatial UV map may be a training pair from the training dataset, both representing the same subject but captured at a different quality (for example, being captured by different 3D camera systems).

At operation 3.4, parameters of the generator neural network are updated based on a comparison of the candidate high quality spatial UV map and the reconstructed candidate high quality spatial UV map. The comparison may be performed by way of a generator loss function. An optimisation procedure, such as gradient descent, may be applied to the loss function to determine the updates to the parameters of the generator neural network. A comparison between the candidate high quality spatial UV map and the corresponding ground truth high quality spatial UV map may additionally be used when updating the parameters of the generator neural network.

At operation 3.5, parameters of the discriminator neural network are updated based on a comparison of the candidate high quality spatial UV map and the reconstructed candidate high quality spatial UV map and a comparison of the high quality ground truth spatial UV maps and the reconstructed high quality ground truth spatial UV map. The comparison may be performed by way of a discriminator loss function. An optimisation procedure, such as gradient descent, may be applied to the loss function to determine the updates to the parameters of the discriminator neural network.

Operations 3.1 to 3.5 may be iterated until a threshold condition is met. Different spatial UV maps from the training dataset may utilised during each iteration.

FIG. 4 shows an overview of an example method of pre-processing 3D facial data. In some embodiments, raw 3D facial data is not in a form that can be processed directly by the neural networks described herein. A pre-processing step 40o is used to convert this raw 3D data into a UV facial map that can be processed by the generator and/or discriminator neural networks. The following description will describe the pre processing method in terms of pre-processing the training data, but it will be apparent that elements of the method could equally be applied to the method of enhancing 3D facial data, for example as described in relation to FIG. 1 above.

Prior to training the neural network, pairs of high quality raw scans (yᵣ) and low quality raw scans (xᵣ) 402 are identified in the training dataset. The corresponding pairs of meshes depict the same subject, but with a different structure (e.g. topology) in terms of, for example, vertex number and triangulation. Note that it not necessarily the case that the high quality raw scan has a higher number of vertices than the low quality raw scan; correctly embodying the characteristics of the human face is what defines the overall scan quality. For example, some scanners that produce scans with a high number of vertices may utilise methods that result in unnecessary points on top of one another, resulting in a complex graph with low surface detail. In some embodiments, the high quality raw scans (yᵣ) are also preprocessed in this way-3D

The high quality raw scans (yᵣ) and low quality raw scans (xᵣ) (402) are each mapped to a template 404 (T) that describes them both with the same topology. An example of such a template is the LSFM model. The template comprises a plurality of vertices sufficient to depict high levels of facial detail (in the example of the LSFM model, 54,000 vertices).

During training, the raw scans of the high quality raw scans (yᵣ) and low quality raw scans (xᵣ) 402 are brought into correspondence by non-rigidly morphing the template mesh 404 to each of them. The non-rigid morphing of the template mesh may be performed using, for example, an optimal-step Non-rigid Iterative Closest Point (NICP) algorithm. The vertices may, for example, be weighted according to the Euclidean distance measured from a given feature in the facial scan, such as the tip of the nose. For example, the greater the distance from the nose tip to a given vertex, the larger the weight assigned to that vertex is. This can help remove noisy information recorded in the facial scan in the outer regions of the raw scan.

The meshes of the facial scans are then converted to a sparse spatial UV map 406. UV maps are usually utilised to store texture information. In this method the spatial location of each vertex of the mesh is represented as an RBG value in UV space. The mesh is unwrapped into UV space to acquire UV coordinates of the mesh vertices. The mesh may be unwrapped, for example, using an optimal cylindrical unwrapping technique.

In some embodiments, prior to storing the 3D co-ordinates in UV space, the mesh is aligned by performing a General Procrustes Analysis (GPA). The meshes may also be normalised to a [−1,1] scale.

The sparse spatial UV map 406 is then converted to an interpolated UV map 408 with a higher number of vertices. Two-dimensional interpolation may be used in the UV domain to fill out the missing areas to produce a dense illustration of the originally sparse UV map 406. Examples of such interpolation methods include two-dimensional nearest point interpolation or barycentric interpolation.

In embodiments where the number of vertices is more than 50,000, the UV map size may be chosen to be 256×256×3, which can assist in retrieving a high precision point cloud with negligible resampling errors.

FIG. 5 shows an overview of an example method of pre-training a discriminator neural network 500. In some embodiments, the discriminator neural network 204 is pre-trained prior to adversarial training with the generator neural network 202. Pre-training the discriminator neural network 204 can reduce the occurrence of mode collapse in the generative adversarial training.

The discriminator neural network 204 is pre-trained on with high quality real facial UV maps 502. A real high quality spatial UV map 502 is input into the discriminator neural network 204, which generates an embedding of the real high quality spatial UV map 502 and generates a reconstructed real high quality spatial UV map 504 from the embedding. The parameters of the discriminator neural network 204 are updated based on a comparison of real high quality spatial UV map 502 and the reconstructed real high quality spatial UV map 504. A discriminator loss function 506 may be used to compare the real high quality spatial UV map 502 and the reconstructed real high quality spatial UV map 504, such as [symbol] _{D}= [symbol] _{y}[ [symbol] (y)] for example.

The data on which the discriminator neural network 204 is per-trained (i.e. pre-training data) may be different from the training data used in the adversarial training described above. The batch size used during pre-training may, for example, be 16.

The pre-training may be performed until a threshold condition is met. The threshold condition may be a threshold number of training epochs. For example, the pre-training may be performed for three-hundred epochs. The learning rate may be altered after a sub-threshold number of epochs, such as every thirty epochs.

The initial parameters of the discriminator neural network 204 and generator neural network 202 may be chosen based on the parameters of the pre-trained discriminator neural network.

FIG. 6 shows an example of the structure of a neural network for enhancing 3D facial data. Such a neural network architecture may be used for the discriminator neural network 204 and/or the generator neural network 202.

In this example, the neural network 106 is in the form of an autoencoder. The neural network comprises a set of encoder layers 600 operable to generate an embedding 602 from an input UV map 604 of a facial scan. The neural network further comprises a set of decoder layers 608 operable to generate an output UV map 610 of a facial scan from the embedding 602.

The encoder layers 600 and decoder layers 608 each comprise a plurality of convolutional layers 612. Each convolutional layer 612 is operable to apply one or more convolutional filters to the input of said convolutional layer 612. For example, one or more of the convolutional layers 612 may apply a two-dimensional convolutional block with kernel size three, a stride of one, and a padding size of one. However, other kernel sizes, strides and padding sizes may alternatively or additionally be used. In the example shown, there are a total of twelve convolutional layers 612 in the encoding layers 600 and a total of thirteen convolutional layers 612 in the decoding layers 608. Other numbers of convolutional layers 612 may alternatively be used.

Interlaced with the convolutional layers 612 of the encoder layers 600 are a plurality of subsampling layers 64 (also referred to herein as down-sampling layers). One or more convolutional layers 612 may be located between each subsampling layer 64. In the example shown, two convolutional layers 612 are applied between each application of a subsampling layer 64. Each subsampling layer 614 is operable to reduce the dimension of the input to that subsampling layer. For example, one or more of the subsampling layers may apply an average two-dimensional pooling with kernel and stride sizer of two. However, other subsampling methods and/or subsampling parameters may alternatively or additionally be used.

One or more fully connected layers 616 may also be present in the encoder layers 600, for example as the final layer of the encoder layers that outputs the embedding 602 (i.e. at the bottleneck of the autoencoder). The fully connected layers 616 project an input tensor to a latent vector, or vice versa.

The encoder layers 600 act on the input UV map 604 of a facial scan (which in this example comprises a 256×256×3 tensor, i.e. a 256×256 RBG values, though other sizes are possible) by performing a series of convolutions and subsampling operations, followed by a fully connected layer 616 to generate an embedding 602 of size h (i.e. the bottleneck size is h). In the example shown, h is equal to one-hundred and twenty-eight.

Interlaced with the convolutional layers 612 of the decoder layers 6o8 are a plurality of upsampling layers 618. One or more convolutional layers 612 may be located between each upsampling layer 618. In the example shown, two convolutional layers 612 are applied between each application of a upsampling layer 618. Each upsampling layer 618 is operable to increase the dimension of the input to that upsampling layer. For example, one or more of the upsampling layers 618 may apply a nearest neighbour method with scale factor two. However, other upsampling methods and/or upsampling parameters (e.g. scale factors) may alternatively or additionally be used.

One or more fully connected layers 616 may also be present in the decoder layers 608, for example as the initial layer of the encoder layers that takes the embedding 602 as an input (i.e. at the bottleneck of the autoencoder).

The decoder layers 608 may further comprise one or more skip connections 620. The skip connections 620 inject the output/input of a given layer into the input of a later layer. In the example shown, the skip connections inject the output of the initial fully connected layer 616 into the first upscaling layer 618a and second upscaling layer 618b. This can result in more compelling visual results when using the output UV map 602 from the neural network 106.

One or more activation functions are used in the layers of the neural network 106. For example, the ELU activation function may be used. Alternative or additionally, a Tanh activation function may be used in one or more of the layers. In some embodiments, the final layer of the neural network may have a Tanh activation function. Other activation functions may alternative or additionally be used.

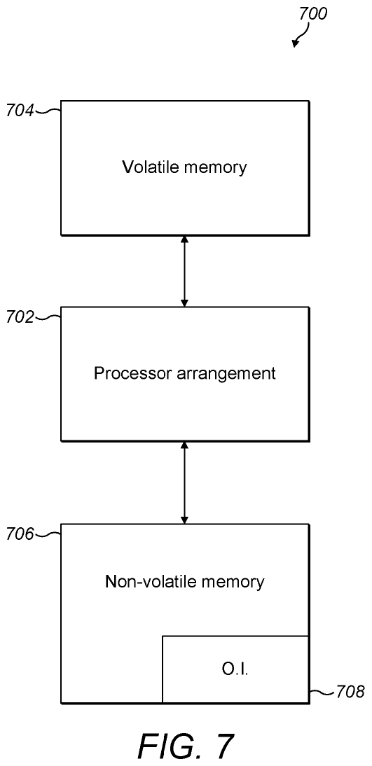

FIG. 7 shows a schematic example of a system/apparatus for performing any of the methods described herein. The system/apparatus shown is an example of a computing device. It will be appreciated by the skilled person that other types of computing devices/systems may alternatively be used to implement the methods described herein, such as a distributed computing system.

The apparatus (or system) 700 comprises one or more processors 702. The one or more processors control operation of other components of the system/apparatus 700. The one or more processors 702 may, for example, comprise a general purpose processor. The one or more processors 702 may be a single core device or a multiple core device. The one or more processors 702 may comprise a Central Processing Unit (CPU) or a graphical processing unit (GPU). Alternatively, the one or more processors 702 may comprise specialised processing hardware, for instance a RISC processor or programmable hardware with embedded firmware. Multiple processors may be included.

The system/apparatus comprises a working or volatile memory 704. The one or more processors may access the volatile memory 704 in order to process data and may control the storage of data in memory. The volatile memory 704 may comprise RAM of any type, for example Static RAM (SRAM), Dynamic RAM (DRAM), or it may comprise Flash memory, such as an SD-Card.

The system/apparatus comprises a non-volatile memory 706. The non-volatile memory 706 stores a set of operation instructions 708 for controlling the operation of the processors 702 in the form of computer readable instructions. The non-volatile memory 706 may be a memory of any kind such as a Read Only Memory (ROM), a Flash memory or a magnetic drive memory.

The one or more processors 702 are configured to execute operating instructions 408 to cause the system/apparatus to perform any of the methods described herein. The operating instructions 708 may comprise code (i.e. drivers) relating to the hardware components of the system/apparatus 700, as well as code relating to the basic operation of the system/apparatus 700. Generally speaking, the one or more processors 702 execute one or more instructions of the operating instructions 708, which are stored permanently or semi-permanently in the non-volatile memory 706, using the volatile memory 704 to temporarily store data generated during execution of said operating instructions 708.

Implementations of the methods described herein may be realised as in digital electronic circuitry, integrated circuitry, specially designed ASICs (application specific integrated circuits), computer hardware, firmware, software, and/or combinations thereof. These may include computer program products (such as software stored on e.g. magnetic discs, optical disks, memory, Programmable Logic Devices) comprising computer readable instructions that, when executed by a computer, such as that described in relation to FIG. 7, cause the computer to perform one or more of the methods described herein.

Any system feature as described herein may also be provided as a method feature, and vice versa. As used herein, means plus function features may be expressed alternatively in terms of their corresponding structure. In particular, method aspects may be applied to system aspects, and vice versa.

Furthermore, any, some and/or all features in one aspect can be applied to any, some and/or all features in any other aspect, in any appropriate combination. It should also be appreciated that particular combinations of the various features described and defined in any aspects of the invention can be implemented and/or supplied and/or used independently.

Although several embodiments have been shown and described, it would be appreciated by those skilled in the art that changes may be made in these embodiments without departing from the principles of this disclosure, the scope of which is defined in the claims.

1. A method comprising:
applying a generator neural network to a low quality spatial UV map to generate a candidate high quality spatial UV map;
applying a discriminator neural network to the candidate high quality spatial UV map to generate a reconstructed candidate high quality spatial UV map;
applying the discriminator neural network to a first high quality ground truth spatial UV map corresponding to the low quality spatial UV map to generate a reconstructed high quality ground truth spatial UV map;
updating first parameters of the generator neural network based on a first comparison of the candidate high quality spatial UV map and the reconstructed candidate high quality spatial UV map; and
updating second parameters of the discriminator neural network based on the first comparison and a second comparison of second high quality ground truth spatial UV maps and the reconstructed high quality ground truth spatial UV map.

2. The method of claim 1, wherein the generator neural network or the discriminator neural network comprises a set of encoding layers configured to convert an input spatial UV map to an embedding and a set of decoding layers configured to convert the embedding to an output spatial UV map.

3. The method of claim 2, wherein third parameters of one or more of the decoding layers are fixed.

4. The method of claim 2, wherein the decoding layers comprise an initial layer, and wherein the initial layer comprises one or more skip connections.

5. The method of claim 1, wherein the generator neural network or the discriminator neural network comprises a plurality of convolutional layers.

6. The method of claim 1, wherein the generator neural network or the discriminator neural comprises one or more fully connected layers.

7. The method of claim 1, wherein the generator neural network or the discriminator neural network comprises one or more upsampling or subsampling layers.

8. The method of claim 1, wherein the generator neural network and the discriminator neural network have a first network structure.

9. The method of claim 1, further comprising
further updating the first parameter based on a third comparison between the candidate high quality spatial UV map and a corresponding third high quality ground truth spatial UV map.

10. The method of claim 1, further comprising:
setting a generator loss function to calculate a generator loss based on a first difference between the candidate high quality spatial UV map and the reconstructed candidate high quality spatial UV map; and
applying an optimization procedure to the generator neural network to update the first parameter based on the generator loss.

11. The method of claim 10, further comprising further setting the generator loss function to calculate the generator loss based on a second difference between the candidate high quality spatial UV map and a corresponding third high quality ground truth spatial UV map.

12. The method of claim 1, updating further comprising:
setting a discriminator loss function to calculate a discriminator loss based on a first difference between the candidate high quality spatial UV map and the reconstructed candidate high quality spatial UV map and a second difference between the first high quality ground truth spatial UV map and the reconstructed high quality ground truth spatial UV map; and
applying an optimization procedure to the discriminator neural network to update the second parameter based on the discriminator loss.

13. The method of claim 1, further comprising pre-training the discriminator neural network to reconstruct fourth high quality ground truth spatial UV maps from input high quality ground truth spatial UV maps.

14. A method comprising:
receiving a low quality spatial UV map of a facial scan;
applying a generator neural network to the low quality spatial UV map to generate a candidate high quality spatial UV map;
obtaining a reconstructed candidate high quality spatial UV map; and
updating parameters of the generator neural network based on a comparison of the candidate high quality spatial UV map and the reconstructed candidate high quality spatial UV map.

15.-16. (canceled)

17. The method of claim 14, wherein the generator neural network comprises a set of encoding layers configured to convert an input spatial UV map to an embedding and a set of decoding layers configured to convert the embedding to an output spatial UV map.

18. The method of claim 17, wherein the decoding layers comprise an initial layer, and wherein the initial layer comprises one or more skip connections.

19. The method of claim 14, wherein the generator neural network comprises a plurality of convolutional layers.

20. The method of claim 14, wherein the generator neural network comprises one or more fully connected layers.

21. The method of claim 14, wherein the generator neural network comprises one or more upsampling or subsampling layers.

22. An apparatus comprising:
one or more processors; and
a memory configured to store computer readable instructions that, when executed by the one or more processors, cause the apparatus to:
receive a low quality spatial UV map of a facial scan;
apply a generator neural network to the low quality spatial UV map to generate a candidate high quality spatial UV map;
obtain a reconstructed candidate high quality spatial UV map; and
update parameters of the generator neural network based on a comparison of the candidate high quality spatial UV map and the reconstructed candidate high quality spatial UV map.
